(19) United States
(12) Patent Application Publication
(10) Pub. No.: US 2004/0108677 A1
(43) Pub. Date: Jun. 10, 2004

(54) Suspension arm mounting structure

(75) Inventor: Yoshitaka Sekiguchi, Wako-shi (JP)

Correspondence Address: MERCHANT & GOULD PC, P.O. BOX 2903, MINNEAPOLIS, MN, 55402-0903, US

(73) Assignee: HONDA MOTOR CO., LTD., Tokyo (JP)

(21) Appl. No.: 10/698,642

(22) Filed: Oct. 30, 2003

(30) Foreign Application Priority Data
Nov. 20, 2002 (JP) 2002-337252
Nov. 20, 2002 (JP) 2002-337254

(51) Int. Cl. B62D 1/00

(52) U.S. Cl. 280/124.109

(57) ABSTRACT

A first suspension arm mounting structure for attaching left and right third lower arms as left and right suspension arms to a subframe is provided. The mounting structure includes a middle crossmember extended transversely across the subframe formed in a rectangular shape, and left and right lower brackets for mounting the left and right third lower arms thereto. The left and right lower brackets are integrally formed with left and right end portions of the middle crossmember.

### FIELD OF THE INVENTION

This invention relates to a suspension arm mounting structure for attaching left and right suspension arms to a frame in order to connect left and right wheels to a vehicle frame via the left and right suspension arms.

### BACKGROUND OF THE INVENTION

Natural gas vehicles having a subframe structure in which a compressed natural gas (CNG) tank is held in a subframe and wheels are mounted to the subframe via suspension arms are known (see, e.g., Japanese Patent Laid-Open Publication No. HEI-11-198623).

The above subframe structure will be described with reference to FIG. 12 hereof.

Referring to FIG. 12, the above subframe structure 200 has a transversely disposed crossmember 201 and left and right suspension frame members 202, 202 attached to the left and right ends of the crossmember 201 via mounting brackets (not shown). The left and right suspension frame members 202, 202 are mounted to the underside of a vehicle body 203.

Left and right suspension arms 204, 204 are vertically swingably attached to the left and right ends of the crossmember 201, respectively. Left and right rear wheels 205, 205 are mounted to end portions 204a, 204a of the left and right suspension arms 204, 204.

In the subframe structure 200, the crossmember 201 and the left and right suspension frame members 202, 202 constitute a substantially U-shaped frame opening rearward, in which frame the CNG tank 206 is placed.

For attaching left and right suspension arms 204, 204 to the left and right suspension frame members 202, 202, mounting brackets (not shown) are generally welded to the left and right suspension frame members 202, 202. To the mounting brackets, the left and right suspension arms 204, 204 are attached with fastening members such as bolts (not shown). The left and right rear wheels 205, 205 are connected to the left and right suspension arms 204, 204.

It is, however, required to initially weld the left and right mounting brackets (not shown) to the left and right suspension frame members 202, 202 in order to mount the left and right suspension arms 204, 204 to the left and right suspension frame members 202, 202. The mounting of the left and right suspension arms 204, 204 to the left and right suspension frame members 202, 202 needs the step of welding the left and right mounting brackets to the left and right suspension frame members 202, 202, which prevents increased productivity. It is desired to simplify the process of mounting suspension arms to a frame to increase productivity.

As described above, the subframe structure 200 includes the frame formed with the crossmember 201 and the left and right suspension frame members 202, 202, having a substantially U shape opening rearward. When the CNG tank 206 is placed in the frame, the frame cannot protect a rear portion 206a of the CNG tank 206.

The CNG tank 206 protrudes at its lower portion downward from the subframe structure 200. If there is a protuberance on the road surface, the CNG tank can collide with the protuberance.

To solve these problems, it seems a possible way to provide the mounting brackets for supporting the left and right suspension arms 204, 204 at rear portions of the subframe structure 200 to protect the rear portion 206a of the CNG tank 206 by the mounting brackets and to prevent a collision of the CNG tank 206 with a protuberance on the road surface.

However, the mounting brackets provided at the rear portions of the subframe structure 200 can hardly withstand an impact force applied from behind the vehicle or an impact force applied from below by a protuberance. It is thus desired to protect a part to be protected such as a CNG tank in a preferable manner.

### SUMMARY OF THE INVENTION

According to an aspect of the present invention, there is provided a suspension arm mounting structure for attaching left and right suspension arms to a subframe which is mountable to a main frame of a vehicle body, which structure comprises: a crossmember extending transversely across the subframe; and left and right mounting parts for mounting the left and right suspension arms thereto; the left and right mounting parts being integrally formed with left and right end portions of the crossmember, respectively.

The left and right mounting parts for mounting the left and right suspension arms thereto are integrally formed with the left and right end portions of the crossmember extended across the subframe. This allows a reduction in the number of components and elimination of the step of attaching left and right mounting parts to the crossmember.

Further, the integral formation of the left and right mounting parts with the left and right end portions of the crossmember increases the rigidities of the left and right mounting parts.

Preferably, the subframe is formed in a substantially rectangular shape with left and right side frame members and front and rear crossmembers. The crossmember is extended between the left and right side frame members. The extension of the crossmember between the left and right side frame members of the subframe increases the rigidity of the subframe.

According to another aspect of the present invention, there is provided a suspension arm mounting structure for attaching left and right suspension arms to a frame of a vehicle body, which structure comprises: a crossmember provided on the frame and extending transversely of the vehicle body; left and right mounting members provided at the crossmember and extending downwardly from the crossmember for mounting the left and right suspension arms thereto; and a connecting member for interconnecting the left and right mounting members.

The interconnection of the left and right mounting members with the connecting member can reinforce the left and right mounting members. The rigidity of the left and right mounting members can be resultantly increased to firmly support the left and right suspension arms with the left and right mounting members. The simple structure of interconnecting the left and right mounting members with the connecting member allows the reinforcement of the left and right mounting members, facilitating the production.

The left and right mounting members are extended downward from the crossmember so that the left and right mounting members and the connecting member form a partition between a forward area and a rearward area of the crossmember. If an impact force is applied from the rearward area to the left and right mounting members and the connecting member, the impact force can be received by the left and right mounting members and the connecting member.

In addition, the rigidity provided to the left and right mounting members and the connecting member can prevent the deformation of the left and right mounting members and the connecting member if the left and right mounting members and the connecting member contact a protuberance on the road surface, for example.

Desirably, the bottom surface of the connecting member is located below a bottom surface of a member to be protected such as fuel tanks. The location of the bottom surface of the connecting member below the bottom surfaces of the fuel tanks can cause the connecting member to collide with a protuberance, if any, on the road surface before the fuel tanks collide with the protuberance, preventing the fuel tanks from colliding with the protuberance. If an impact force is applied from behind to the left and right mounting members and the connecting member, the impact force can be received by the left and right mounting members and the connecting member.

### BRIEF DESCRIPTION OF THE DRAWINGS

Preferred embodiments of the present invention will be described in detail below, by way of example only, with reference to the accompanying drawings, in which:

FIG. 1 is a perspective view illustrating the relationship between a subframe having a suspension arm mounting structure according to the present invention, a fuel tank and a vehicle body;

FIG. 2 is a perspective view of the subframe having the suspension arm mounting structure according to the present invention;

FIG. 3 is a perspective view of the subframe shown in FIG. 2 when viewed from below;

FIG. 4 is a side view of the subframe shown in FIG. 2;

FIG. 5 is a plan view of the subframe shown in FIG. 2;

FIG. 6 is a cross-sectional view taken along line 6-6 in FIG. 2;

FIG. 7 is a cross-sectional view taken along line 7-7 in FIG. 2;

FIG. 8 is a cross-sectional view taken along line 8-8 in FIG. 2;

FIG. 9 is a cross-sectional view taken along line 9-9 in FIG. 2;

FIGS. 10A and 10B are perspective views of a material and a product for producing a first suspension arm mounting structure;

FIG. 11 is a rear view of the subframe shown in FIG. 2; and

FIG. 12 is a schematic diagram of a conventional subframe structure provided with suspension arms.

### DETAILED DESCRIPTION OF THE PREFERRED EMBODIMENTS

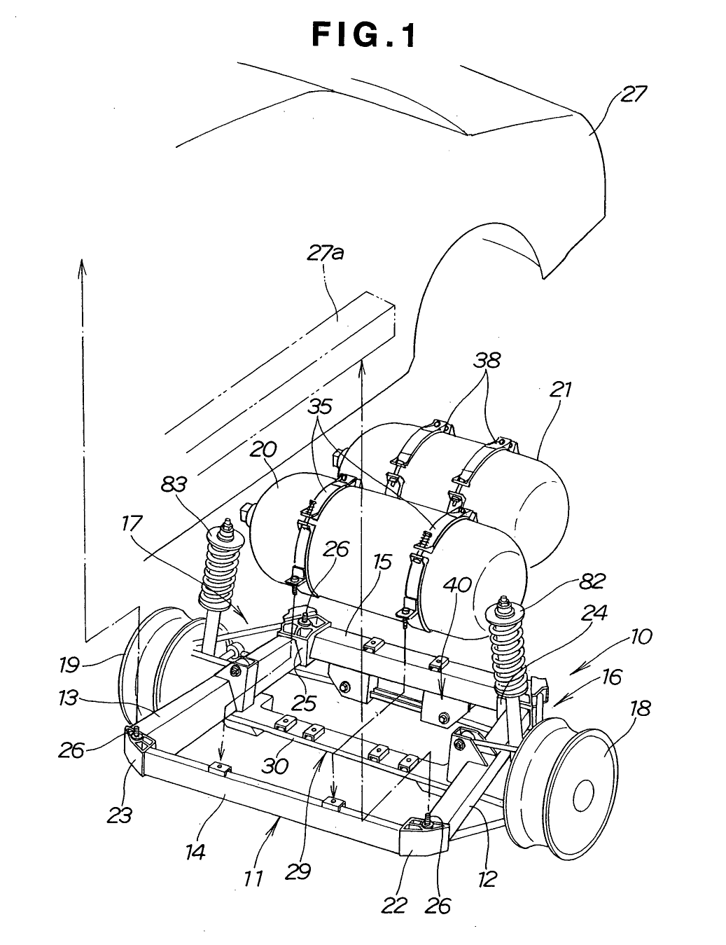

An embodiment of the present invention will be described in detail with reference to FIGS. 1 to 11.

Referring to FIG. 1, a subframe 10 to be mounted to a main frame 27a of a vehicle body 27 includes a rectangular frame 11. The frame 11 consists of a left side frame member 12, a right side frame member 13, a front crossmember 14 and a rear crossmember 15. Left and right suspension arm units 16, 17 are mounted to the frame 11. Left and right rear wheel rims 18, 19 are supported by the left and right suspension arm units 16, 17.

Front and rear two fuel tanks 20, 21 are placed within the frame 11 of the subframe 10. Left and right front corner members (corner members) 22, 23 and left and right rear corner members (corner members) 24, 25 provided at the four corners of the frame 11 are secured to the main frame 27a with a plurality of mounting bolts 26 as shown by arrows. In this manner, the left and right rear wheel rims 18, 19 and the front and rear fuel tanks 20, 21 as members to be protected are mounted to the vehicle body 27 via the subframe 10.

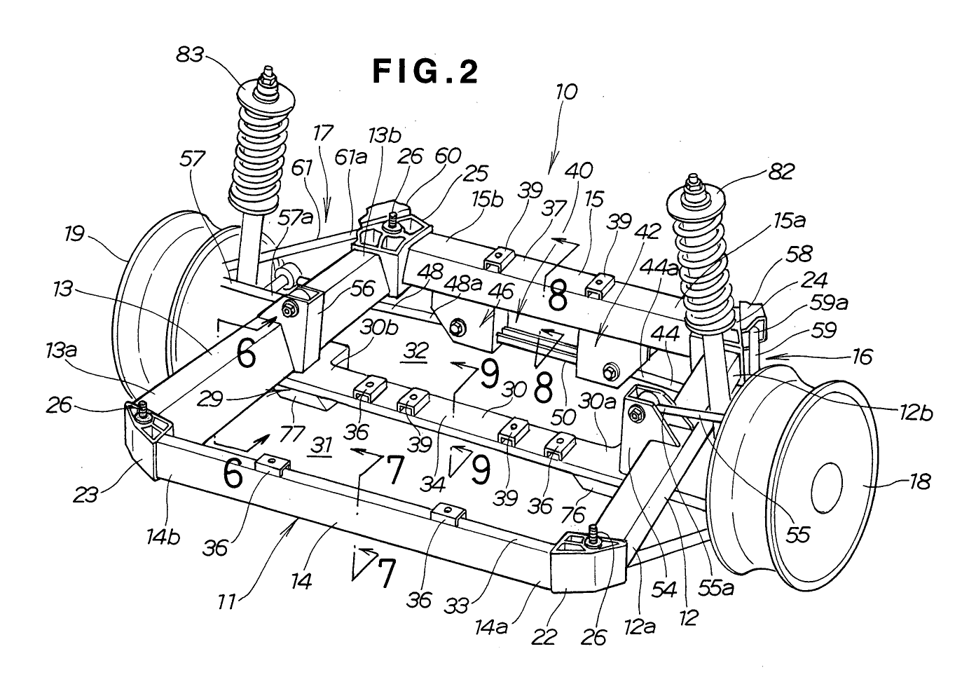

As shown in FIG. 2, each of the left and right side frame members 12, 13 and the front and rear crossmembers 14, 15 is a cross-sectionally uniform and linear component. The front crossmember 14 is longer than the rear crossmember 15. A front end 12a of the left side frame member 12 and a left end 14a of the front crossmember 14 are connected to the left front corner member 22.

A rear end 12b of the left side frame member 12 and a left end 15a of the rear crossmember 15 are connected to the left rear corner member 24. A front end 13a of the right side frame member 13 and a right end 14b of the front crossmember 14 are connected to the right front corner member 23.

A rear end 13b of the right side frame member 13 and a right end 15b of the rear crossmember 15 are connected to the right rear corner member 25. The frame 11 is formed substantially trapezoidal in a plan view.

As shown in FIG. 1, the front and rear fuel tanks 20, 21 are placed within the frame 11.

A middle crossmember (crossmember) 30 of a first suspension arm mounting structure (suspension arm mounting structure) 29 is extended between substantially middle portions of the left and right side frame members 12, 13, defining a front receiving space 31 and a rear receiving space 32. The front and rear fuel tanks 20, 21 (see FIG. 1) are held in the front and rear receiving spaces 31, 32, respectively.

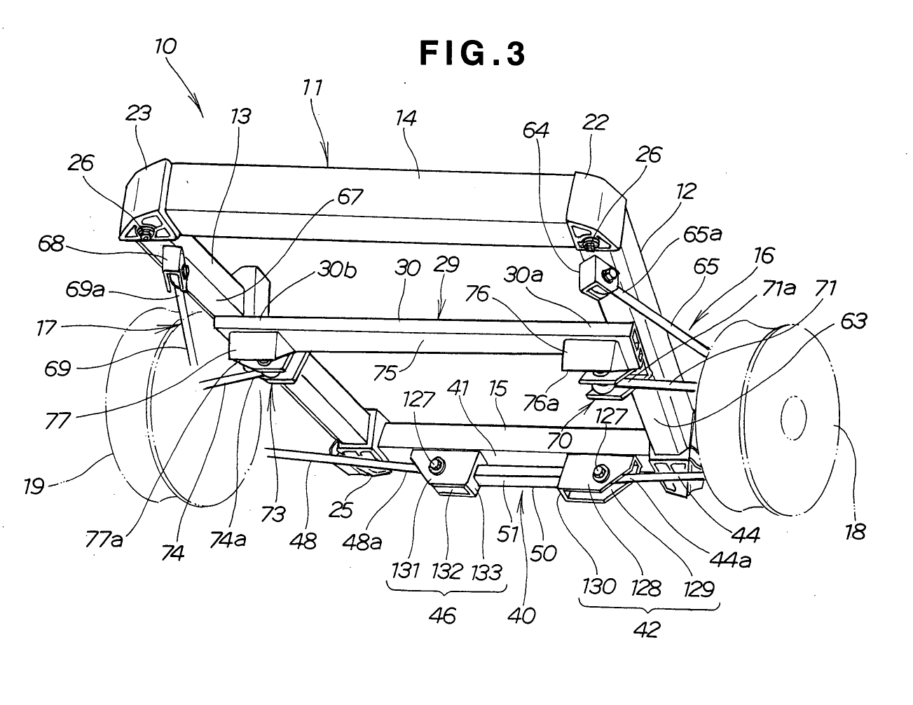

The first suspension arm mounting structure 29 are shown in FIGS. 3, 9 and 10 and will be described in detail below.

The front crossmember 14 and the middle crossmember 30 each have on their upper surfaces 33, 34 two front tank fixing parts 36 for fixing the front fuel tank 20 via mounting belts 35, 35 (see FIG. 1). The rear crossmember 15 and the middle crossmember 30 each have on their upper surfaces 37, 34 two rear tank fixing parts 39 for fixing the rear fuel tank 21 via mounting belts 38, 38 (see FIG. 1).

As shown in FIG. 3, a second suspension arm mounting structure (suspension arm mounting structure) 40 is provided on a lower surface 41 of the rear crossmember 15.

The second suspension arm mounting structure 40 includes a left rear lower bracket (left mounting member) 42 provided on the lower surface 41 at the left end 15a of the rear crossmember 15 and a right rear lower bracket (right mounting member) 46 provided on the lower surface 41 at the right end 15b of the rear crossmember 15. The left rear lower bracket 42 and the right rear lower bracket 46 protrude downward from the lower surface 41 of the rear crossmember 15. The left rear lower bracket 42 and the right rear lower bracket 46 are interconnected by a connecting member 50.

A proximal end 44a of a first left lower arm (suspension arm) 44 of the left suspension arm unit 16 is vertically swingably attached to the left rear lower bracket 42. A proximal end 48a of a first right lower arm (suspension arm) 48 of the right suspension arm unit 17 is vertically swingably attached to the right rear lower bracket 46.

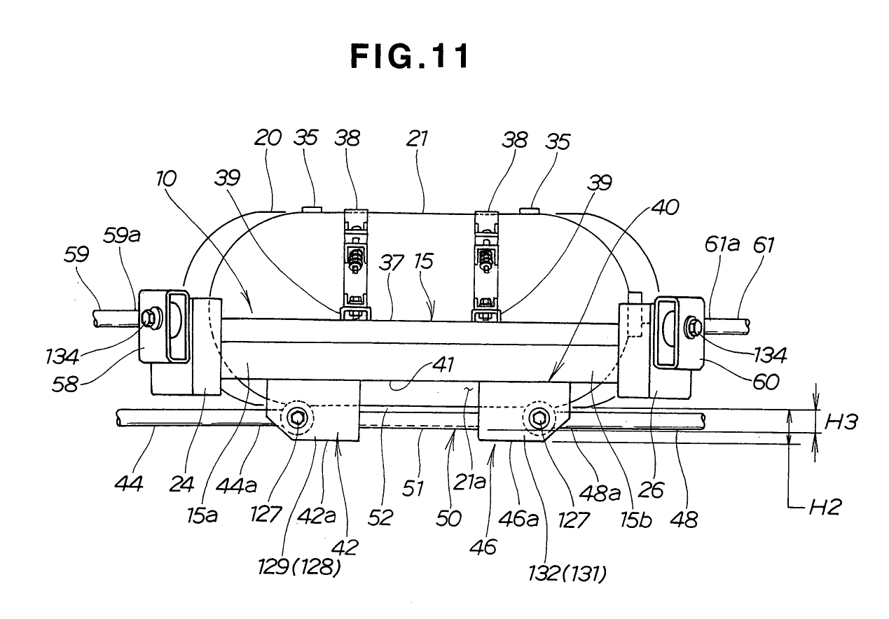

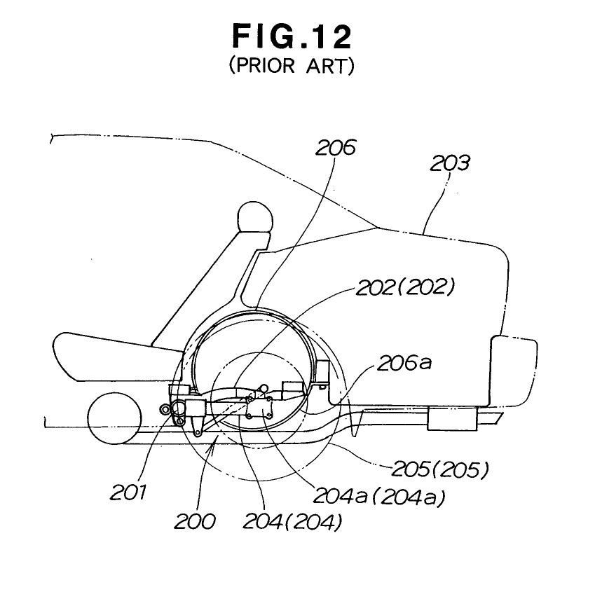

A bottom surface 51 of the connecting member 50 is, as shown in FIG. 11, located below a bottom surface 52 of a member to be protected such as the front and rear fuel tanks 20, 21.

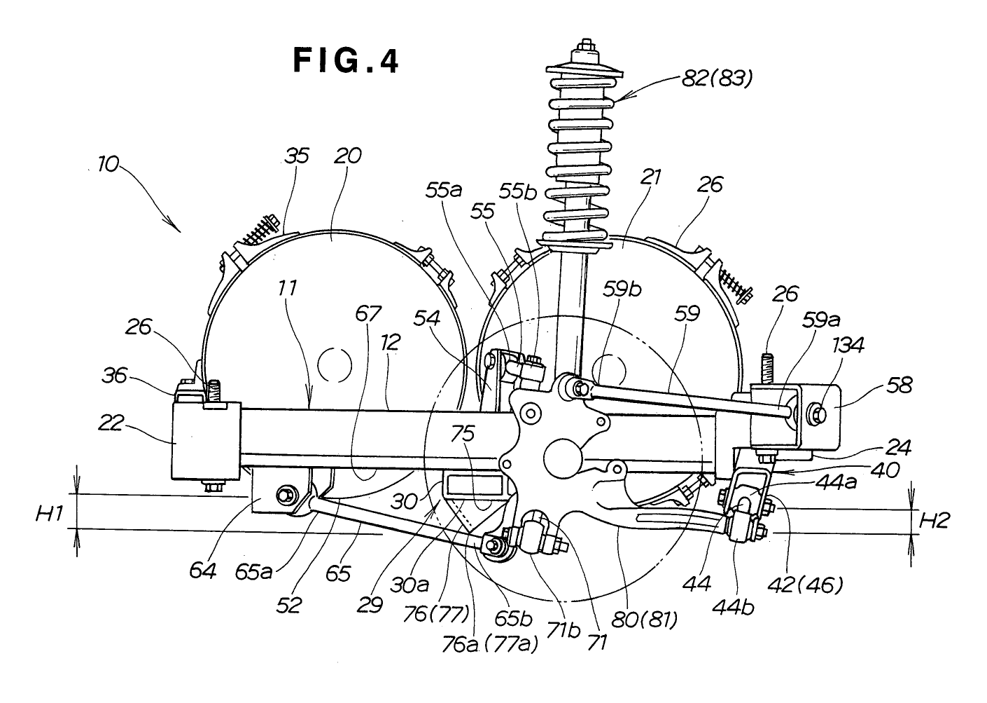

The second suspension arm mounting structure 40 will be described in detail with reference to FIGS. 4 and 11.

A proximal end portion 55a of a left upper arm (suspension arm) 55 of the left suspension arm unit 16 is vertically swingably attached to a left upper bracket 54 mounted to the left side frame member 12.

A proximal end portion 57a of a right upper arm 57 of the right suspension arm unit 17 is vertically swingably attached to a right upper bracket 56 mounted to the right side frame member 13.

A proximal end portion 59a of a left rear arm (suspension arm) 59 of the left suspension arm unit 16 is vertically swingably attached to a left corner bracket 58 mounted to the left rear corner member 24.

A proximal end portion 61a of a right rear arm (suspension arm) 61 of the right suspension arm unit 17 is vertically swingably attached to a right corner bracket 60 mounted to the right rear corner member 25.

Left and right brake supporting members 80, 81 (see FIG. 4) have left and right shock absorbers 82, 83, respectively.

As shown in FIG. 3, a left lower bracket 64 is provided on a lower surface 63 of the left side frame member 12. A proximal end portion 65a of a second left lower arm (suspension arm) 65 of the left suspension arm unit 16 is vertically swingably attached to the left lower bracket 64.

A right lower bracket 68 is provided on a lower surface 67 of the right side frame member 13. A proximal end portion 69a of a second right lower arm (suspension arm) 69 of the right suspension arm unit 17 is vertically swingably attached to the right lower bracket 68.

As described with FIG. 2, the middle crossmember 30 of the first suspension arm mounting structure 29 is extended between the left and right side frame members 12, 13. The extension of the middle crossmember 30 between the left and right side frame members 12, 13 of the subframe 10 can increase the rigidity of the subframe 10.

The first suspension arm mounting structure 29 has a left lower bracket (left mounting part) 70 integrally formed with a left end portion 30a of the middle crossmember 30 and a right lower bracket 73 (right mounting part) integrally formed with a right end portion 30b of the middle crossmember 30.

A proximal end portion 71a of a third left lower arm (suspension arm) 71 of the left suspension arm unit 16 is vertically swingably attached to the left lower bracket 70. A proximal end portion 74a of a third right lower arm (suspension arm) 74 of the right suspension arm unit 17 is vertically swingably attached to the right lower bracket 73.

As described with FIG. 2, the left and right lower brackets 42, 46 as components of the second suspension arm mounting structure 40 are provided on the lower surface 41 of the rear crossmember 15.

The proximal end 44a of the first left lower arm 44 of the left suspension arm unit 16 is vertically swingably attached to the left rear lower bracket 42. The proximal end 48a of the first right lower arm 48 of the right suspension arm unit 17 is vertically swingably attached to the right rear lower bracket 46.

Left and right protecting members 76, 77 are provided on a lower surface 75 of the middle crossmember 30 at the left and right end portions 30a, 30b.

As shown in FIG. 4, the proximal end portion 55a of the left upper arm 55 is coupled to the left upper bracket 54 mounted to the left side frame member 12. A distal end portion 55b of the left upper arm 55 is coupled to the left brake supporting member 80.

The proximal end portion 59a of the left rear arm 59 is coupled to the left corner bracket 58 mounted to the left rear corner member 24. A distal end portion 59b of the left rear arm 59 is coupled to the left brake supporting member 80.

The left lower bracket 64 is provided on the lower surface 67 of the left side frame member 12. The proximal end portion 65a of the second left lower arm 65 is coupled to the left lower bracket 64. A distal end portion 65b of the second left lower arm 65 is coupled to the left brake supporting member 80.

The left lower bracket 70 (see FIG. 3) is integrally formed with the left end portion 30a of the middle crossmember 30 as a component of the first suspension arm mounting structure 29. The proximal end portion 71a (see FIG. 3) of the third left lower arm 71 is coupled to the left lower bracket 70. A distal end portion 71b of the third left lower arm 71 is coupled to the left brake supporting member 80.

The left and right rear lower brackets 42, 46 as components of the second suspension arm mounting structure 40 are provided on the lower surface 41 of the rear crossmember 15 shown in FIG. 3.

The proximal end portion 44a of the first left lower arm 44 is coupled to the left rear lower bracket 42. A distal end portion 44b of the first left lower arm 44 is coupled to the left brake supporting member 80.

In this manner, five arms of the left upper arm 55, left rear arm 59, first left lower arm 44, second left lower arm 65 and third left lower arm 71 as components of the left suspension arm unit 16 connect the left brake supporting member 80 to the subframe 10.

Like the left brake supporting member 80, the right brake supporting member 81 as a component of the right suspension arm unit 17 is connected to the subframe 10 by five arms of the right upper arm 57, right rear arm 61, first right lower arm 48, second right lower arm 69 and third right lower arm 74 (see FIGS. 2 and 3).

Lower edges 76a, 77a of the left and right protecting members 76, 77 (see also FIG. 3 for the right protecting member 77) provided on the lower surface 75 of the middle crossmember 30 are located below the bottom surfaces 52 of the front and rear fuel tanks 20, 21 by H.

In the second suspension arm mounting structure 40 provided on the lower surface 41 of the rear crossmember (crossmember) 15 shown in FIG. 3, lower edges 42a, 46a (see FIG. 11) of the left and right rear lower brackets 42, 46 (see also FIG. 3 for the right rear lower bracket 46) are located below the bottom surfaces 52 of the front and rear fuel tanks 20, 21 by H2.

The bottom surfaces 52 of the front and rear fuel tanks 20, 21 are thus protected by the left and right protecting members 76, 77 and the left and right rear lower brackets 42, 46.

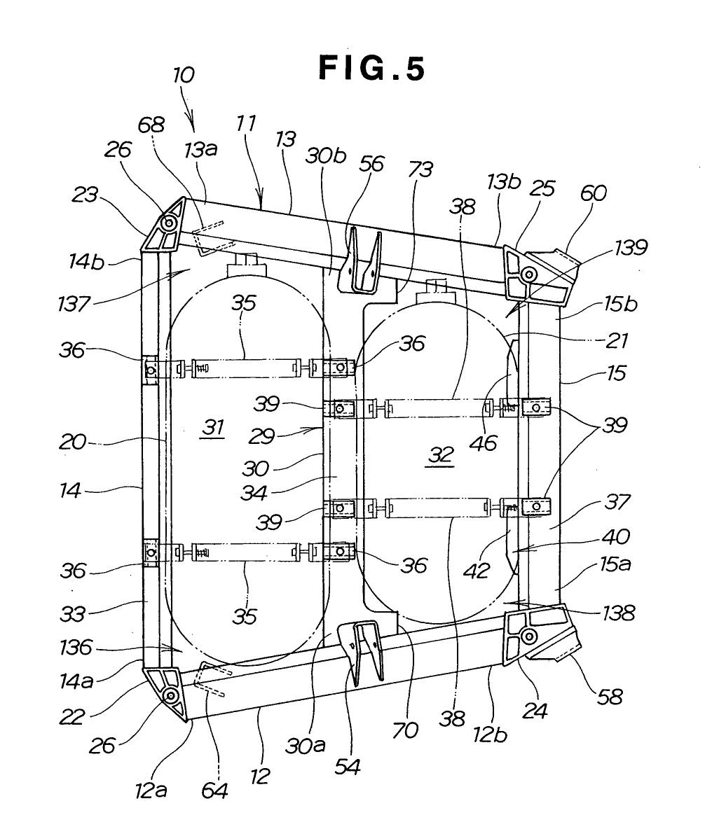

Referring to FIG. 5, each of the left and right side frame members 12, 13 and the front and rear crossmembers 14, 15 is uniform in cross section and linear, as described above. There are thus no cross-sectional variations and bends in the left and right side frame members 12, 13 and the front and rear crossmembers 14, 15, so that, upon a collision or a suspension power input, occurrence of stress concentration in the left and right side frame members 12, 13 and the front and rear crossmembers 14, 15 can be prevented. The thicknesses of the left and right side frame members 12, 13 and the front and rear crossmembers 14, 15 can be made thinner to reduce the weight of the subframe structure.

The front crossmember 14 is made longer than the rear crossmember 15 so that the frame 11 can be made substantially trapezoidal with the longer front side when mounted in the vehicle body. When an impact force is applied to the rear crossmember 15, the impact force can be efficiently transmitted to the front crossmember 14 via the left and right side frame members 12, 13. The impact force can thus be received by the entire frame 11, which allows the thicknesses of the left and right side frame members 12, 13 and the front and rear crossmembers 14, 15 constituting the frame 11 to be made smaller to reduce the weight of the subframe 10.

The front and rear fuel tanks 20, 21 are held within the frame 11 formed with the left and right side frame members 12, 13 and the front and rear crossmembers 14, 15. This arrangement allows the rear crossmember 15 to be disposed behind the rear fuel tank 21 to receive an impact force to protect the rear fuel tank (fuel tank) 21.

The subframe 10 is configured by butt welding the front end 12a of the left side frame member 12 and the left end 14a of the front crossmember 14 to the left front corner member 22, butt welding the rear end 12b of the left side frame member 12 and the left end 15a of the rear crossmember 15 to the left rear corner member 24, butt welding the front end 13a of the right side frame member 13 and the right end 14b of the front crossmember 14 to the right front corner member 23, and butt welding the rear end 13b of the right side frame member 13 and the right end 15b of the rear crossmember 15 to the right rear corner member 25.

In this manner, without providing gusset plates inside the four corners of the frame 11, the left and right side frame members 12, 13 and the front and rear crossmembers 14, 15 are interconnected by butt welding via the four corner members 22, 23, 24 and 25. A left front space 136, right front space 137, left rear space 138 and right rear space 139 (spaces) can be provided inside the four corners of the frame 11.

Those spaces 136, 137, 138 and 139 can be effectively utilized to determine the layouts of tubes and hoses (not shown) to be connected to the front and rear fuel tanks 20, 21 and the layouts of harnesses (not shown) to be connected to electrical components. The layout freedom of the tubes, hoses and harnesses can thus be increased. In addition, the frame 11 forming the four spaces 136, 137, 138 and 139 can protect the tubes, hoses and harnesses.

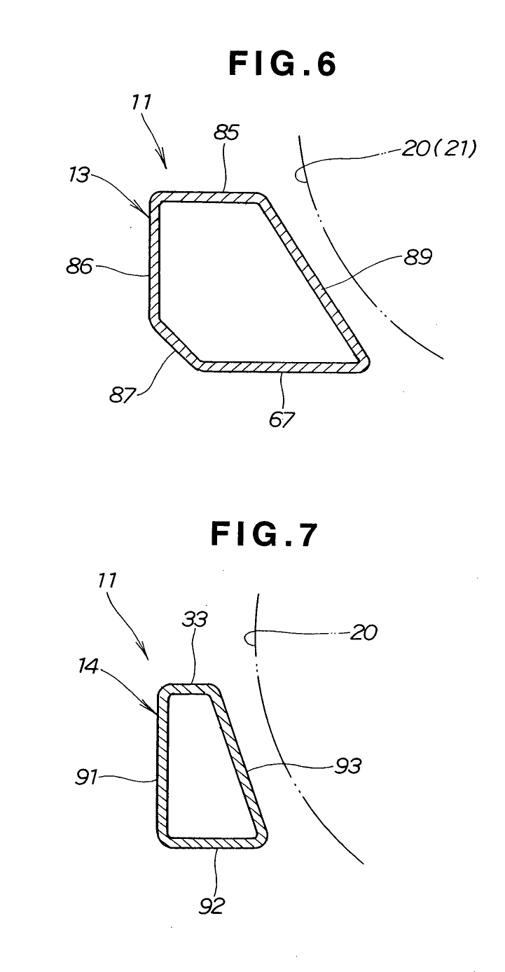

The right side frame member 13 shown in FIG. 6 is formed pentagonal with an upper surface 85, an outside vertical wall 86, an outside downwardly inclined wall 87, the lower surface 67 and an inside inclined wall 89.

The pentagonal right side frame member 13 is a cross-sectionally uniform and linear component. The formation of the right side frame member 13 as a cross-sectionally uniform and linear component allows the molding of the right side frame member 13 by extrusion, for example, resulting in increased productivity and reduced cost.

The outward and upward inclination from the lower surface 67 to the upper surface 85 of the inside inclined wall 89 of the right side frame member 13 provides a larger space in the frame 11. The right side frame member 13 can be prevented from interfering with the front and rear fuel tanks 20, 21.

The left side frame member 12 is identical with the right side frame member 13. The description of the right side frame member 13 also serves as the description of the left side frame member 12.

The front crossmember 14 shown in FIG. 7 is formed quadrangular with an upper surface 33, an outside vertical wall 91, a lower surface 92 and an inside inclined wall 93.

The quadrangular front crossmember 14 is a cross-sectionally uniform and linear component. The formation of the front crossmember 14 as a cross-sectionally uniform and linear component allows the molding of the front crossmember 14 by extrusion, for example, resulting in increased productivity and cost reduction.

The outward and upward inclination from the lower surface 92 to the upper surface 33 of the inside inclined wall 93 of the front crossmember 14 provides a larger space in the frame 11. The front crossmember 14 can be prevented from interfering with the front fuel tank 20.

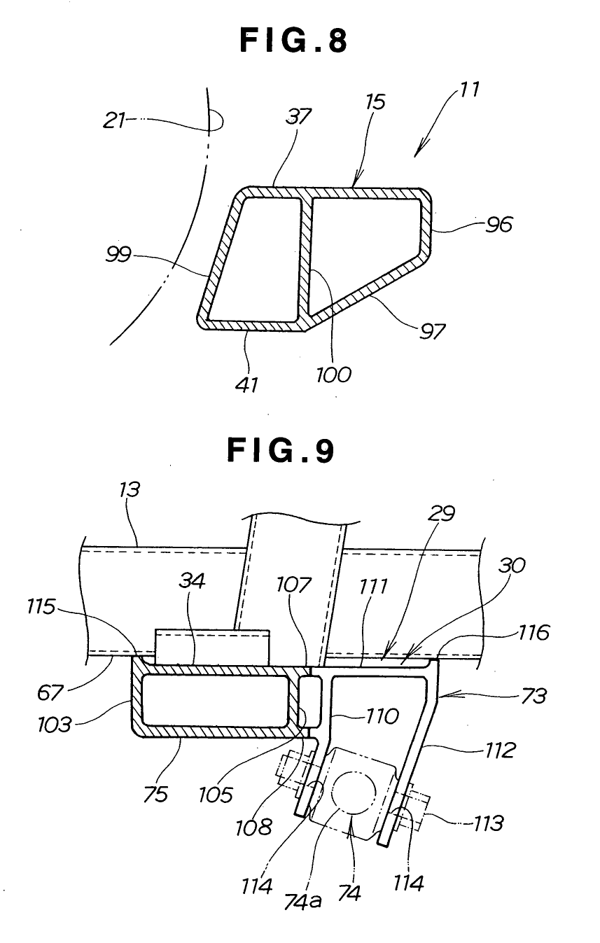

The rear crossmember 15 shown in FIG. 8 is formed pentagonal with an upper surface 37, an outside vertical wall 96, an outside inclined wall 97, the lower surface 41 and an inside inclined wall 99. The upper surface 37 and the lower surface 41 are interconnected by an intermediate wall 100.

The pentagonal rear crossmember 15 is a cross-sectionally uniform and linear component. The formation of the rear crossmember 15 as a cross-sectionally uniform and linear component allows the molding of the rear crossmember 15 by extrusion, for example, resulting in increased productivity and cost reduction.

The outward and upward inclination from the lower surface 41 to the upper surface 37 of the inside inclined wall 99 of the rear crossmember 15 provides a larger space in the frame 11. The rear crossmember 15 can be prevented from interfering with the rear fuel tank 21.

Now, with reference to FIG. 9, the first suspension arm mounting structure 29 according to the present invention will be described.

The first suspension arm mounting structure 29 has the middle crossmember 30 formed in a substantially rectangular shape with the upper surface 34, a front sidewall 103, the lower surface 75 and a rear sidewall 105, and the left and right lower brackets 70, 73 (see FIG. 3 for the left lower bracket 70) integrally formed with the left and right end portions 30a, 30b (see FIG. 3) of the middle crossmember 30 via upper and lower connecting portions 107, 108.

The left lower bracket 70 is identical with the right lower bracket 73. The description of the right lower bracket 73 also serves as the description of the left lower bracket 70.

The right lower bracket 73 includes a front bracket portion 110 connected to the upper and lower connecting portions 107, 108, an overhanging portion 111 projecting rearward from the upper edge of the front bracket portion 110, and a rear bracket portion 112 extending downward from the rear edge of the overhanging portion 111. The front and rear bracket portions 110, 112 are inclined at a given angle with a given space therebetween.

The front and rear bracket portions 110, 112 have mounting holes 114, 114, respectively, for mounting the proximal end portion 74a of the third right lower arm 74 between the bracket portions 110, 112 with a mounting bolt 113.

On the front edge of the upper surface 34 of the middle crossmember 30, a front linear protrusion 115 is formed integrally. On the rear edge of the overhanging portion 111, a rear linear protrusion 116 is formed integrally. The front and rear linear protrusions 115, 116 are welded to the lower surface 67 of the right side frame member 13.

The middle crossmember 30 is a cross-sectionally uniform and linear component. The left and right lower brackets 70, 73 are cross-sectionally uniform and linear components. The formation of the middle crossmember 30 and the left and right lower brackets 70, 73 as cross-sectionally uniform and linear components allows the integral molding of the first suspension arm mounting structure 29 by extrusion, for example.

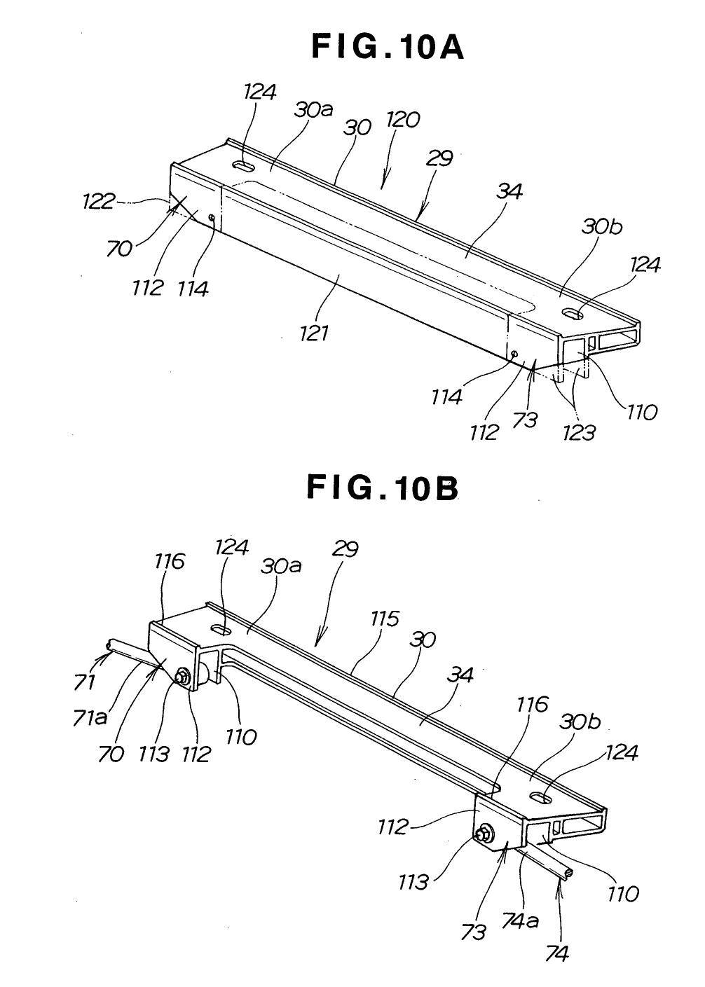

Now, an exemplary method of producing the first suspension arm mounting structure 29 from an extruded material will be described with reference to FIGS. 10A and 10B.

As shown in FIG. 10A, a material 120 for the first suspension arm mounting structure 29 is uniform in cross section and linear.

First, an intermediate portion 121 of the material 120 between the left and right lower brackets 70, 73 is cut away into a substantially U shape. Then, left corner portions 122, 122 (back one not shown) of the left lower bracket 70 are cut away. Right corner portions 123, 123 of the right lower bracket 73 are cut away. The result is the middle crossmember 30 and the left and right lower brackets 70, 73.

Then, elongated holes 124, 124 are formed in the upper surface 34 of the middle crossmember 30 at the left and right end portions 30a, 30b, respectively.

In the front and rear bracket portions 110, 112 of the left lower bracket 70, the mounting holes 114, 114 are coaxially formed (mounting hole 114 in the front bracket 110 not shown), respectively. In the front and rear bracket portions 110, 112 of the right lower bracket 73, the mounting holes 114, 114 are coaxially formed (mounting hole 114 in the front bracket 110 not shown), respectively.

As shown in FIG. 10B, the proximal end portion 71a of the third left lower arm 71 is rotatably mounted between the front and rear bracket portions 110, 112 of the left lower bracket 70 with the mounting bolt 113. The proximal end portion 74a of the third right lower arm 74 is rotatably mounted between the front and rear bracket portions 110, 112 of the right lower bracket 73 with the mounting bolt 113.

As described with FIG. 10A, the material 120 for the first suspension arm mounting structure 29 can be uniform in cross section and linear to be molded by extrusion, increasing the productivity of the first suspension arm mounting structure 29 and reducing its cost.

The first suspension arm mounting structure 29 has the left and right lower brackets 70, 73 for mounting the third left lower arm 71 and the third right lower arm 74 constituting the left and right suspension arms, integrally formed with the left and right end portions 30a, 30b of the middle crossmember 30. The number of components can thus be reduced. In addition, the step of attaching left and right mounting parts to the middle crossmember 30 can be eliminated.

The integral formation of the left and right lower brackets 70, 73 with the left and right end portions 30a, 30b of the middle crossmember 30 can increase the rigidities of the left and right lower brackets 70, 73 and reduce the weights of the right and left lower brackets 70, 73.

The embodiment shown in FIG. 10B has been described with the example of integrally forming the left and right lower brackets 70, 73 in positions rearwardly offset from the longitudinally central axis of the middle crossmember 30, but is not limited thereto. The left and right lower brackets 70, 73 may be integrally formed in positions not offset from the central axis of the middle crossmember 30, that is, in positions coaxial with the central axis of the middle crossmember 30.

Thus integrally forming the left and right lower brackets 70, 73 without offsetting them from the central axis of the middle crossmember 30 allows the first suspension arm mounting structure 29 to be further increased in rigidity.

Now, with reference to FIG. 11, the second suspension arm mounting structure 40 according to the present invention will be described.

The second suspension arm mounting structure 40 is provided on the lower surface 41 of the rear crossmember 15. The second suspension arm mounting structure 40 has the left rear lower bracket 42 provided on the lower surface 41 of the left end portion 15a of the rear crossmember 15, the right rear lower bracket 46 provided on the lower surface 41 of the right end portion 15b of the rear crossmember 15, and the connecting member 50 interconnecting the left and right rear lower brackets 42, 46. The left and right rear lower brackets 42, 46 extend downward from the lower surface 41 of the rear crossmember 15.

The lower edge 42a of the left rear lower bracket 42 is located below the bottom surfaces 52 of the front and rear fuel tanks 20, 21 by H2. The lower edge 46a of the right rear lower bracket 46 is located below the bottom surfaces 52 of the front and rear fuel tanks 20, 21 by H2.

The bottom surface 51 of the connecting member 50 is located below the bottom surfaces 52 of the front and rear fuel tanks 20, 21 by H3.

The connecting member 50 is, as shown in FIGS. 2 and 3, a substantially U-shaped cross-section member formed uniform in cross section and linear. The connecting member 50 can be molded by extrusion, leading to increased productivity and reduced cost.

The left rear lower bracket 42 is, as shown in FIG. 3, U-shaped in cross section, including the front and rear bracket portions 128, 129 longitudinally arranged with a given space therebetween and a wall surface 130 connecting their ends facing the center of the frame 11.

The right rear lower bracket 46 is, like the left rear lower bracket 42, U-shaped in cross section, including the front and rear bracket portions 131, 132 longitudinally arranged with a given space therebetween and a wall surface 133 connecting their ends facing the center of the frame 11.

The proximal end portion 44a of the first left lower arm 44 is rotatably mounted between the front and rear bracket portions 128, 129 of the left rear lower bracket 42 with a mounting bolt 127. The proximal end portion 48a of the first right lower arm 48 is rotatably mounted between the front and rear bracket portions 131, 132 of the right rear lower bracket 46 with a mounting bolt 127.

As described above, the second suspension arm mounting structure 40 can reinforce the left and right rear lower brackets 42, 46 with the connecting member 50 interconnecting the left and right rear lower brackets 42, 46. The increased rigidity of the left and right rear lower brackets 42, 46 allows the first left lower arm 44 and the first right lower arm 48 to be firmly supported by the left and right rear lower brackets 42, 46.

The simple structure of interconnecting the left and right rear lower brackets 42, 46 with the connecting member 50 allows the reinforcement of the left and right rear lower brackets 42, 46, resulting in a simplified configuration.

The left and right rear lower brackets 42, 46 are extended downward from the lower surface 41 of the rear crossmember 15 so that the left and right rear lower brackets 42, 46 and the connecting member 50 can be a partition between a forward area and a rearward area with the rear crossmember 15 intermediate therebetween. If an impact force is applied from the rearward area to the left and right rear lower brackets 42, 46 and the connecting member 50, the left and right rear lower brackets 42, 46 and the connecting member 50 can receive the impact force, protecting the forward area from the impact force.

In addition, the rigidity provided to the left and right rear lower brackets 42, 46 and the connecting member 50 makes the left and right rear lower brackets 42, 46 and the connecting member 50 hard to deform when the left and right rear lower brackets 42, 46 and the connecting member 50 contact a protuberance on the road surface, for example.

The bottom surface 51 of the connecting member 50 is located below the bottom surfaces 52 of the front and rear fuel tanks 20, 21 so that the connecting member 50 collides with a protuberance, if any, on the road surface before the front and rear fuel tanks 20, 21 collide with the protuberance, protecting the front and rear fuel tanks 20, 21 from the protuberance.

If an impact force is applied from behind to the left and right rear lower brackets 42, 46 and the connecting member 50, for example, the left and right rear lower brackets 42, 46 and the connecting member 50 receive the impact force, protecting a rear portion 21a of the rear fuel tank 21 (see FIG. 11) from the impact force.

As shown in FIG. 11, the left corner bracket 58 in a rectangular cross-section tube is attached to the left rear corner member 24. The proximal end portion 59a of the left rear arm 59 is rotatably mounted within the left corner bracket 58 with a mounting bolt 134.

The right corner bracket 60 in a rectangular cross-section tube is attached to the right rear corner member 26. The proximal end portion 61a of the right rear arm 61 is rotatably mounted within the right corner bracket 60 with a mounting bolt 134.

The above embodiment has been described with the example of supporting the left and right rear wheel rims 18, 19 on the frame 11 with the suspension arm units 16, 17, but is not limited thereto. Left and right front wheel rims may be supported instead.

The above embodiment has been described with the example of protruding the left and right lower brackets 70, 73 downward from the middle crossmember 30 as left and right mounting parts for mounting left and right suspension arms thereto, but is not limited thereto. The left and right mounting parts may be protruded in any direction from any portions of the middle crossmember 30.

The above embodiment has been described with the example of providing the left and right lower brackets 70, 73 at the middle crossmember 30 as the left and right mounting parts, but is not limited thereto. The left and right mounting parts may be provided at another crossmember such as the front or rear crossmember 14, 15.

The above embodiment has been described with the example of providing the middle crossmember 30 as a crossmember on the subframe 10, but is not limited thereto. The crossmember may be provided on another frame.

The above embodiment has been described with the example of holding the front and rear two fuel tanks 20, 21 within the frame 11 of the subframe 10, but the number of fuel tanks may be any. In place of fuel tanks, other members to be protected may be placed.

The above embodiment has been described with the example of providing the left and right rear lower brackets 42, 46 on the lower surface 41 of the rear crossmember 15 as left and right mounting parts for mounting suspension arms thereto, but is not limited thereto. The mounting parts may be provided on another portion instead of the lower surface 41 or may be provided at another crossmember instead of the rear crossmember 15.

The above embodiment has been described with the example of providing the rear crossmember 15 as a crossmember in the subframe 10, but is not limited thereto. The crossmember may be provided in another frame.

Obviously, various minor changes and modifications of the present invention are possible in the light of the above teaching. It is therefore to be understood that within the scope of the appended claims the invention may be practiced otherwise than as specifically described.

What is claimed is:

1. A suspension arm mounting structure for attaching left and right suspension arms to a subframe which is mountable to a main frame of a vehicle body, comprising:
a crossmember extending transversely of the subframe; and
left and right mounting parts for mounting the left and right suspension arms thereto, the left and right mounting parts being integrally formed with left and right end portions of the crossmember, respectively.

2. A mounting structure according to claim 1, wherein the subframe is formed into a substantially rectangular shape with left and right side frame members and front and rear crossmembers, and the crossmember is extending between the left and right side frame members.

3. A suspension arm mounting structure for attaching left and right suspension arms to a frame of a vehicle body, comprising:
a crossmember provided on the frame and extending transversely of the vehicle body;
left and right mounting members provided at the crossmember and extending downwardly from the crossmember for mounting the left and right suspension arms thereto; and
a connecting member for interconnecting the left and right mounting members.

4. A mounting structure according to claim 4, wherein the connecting member has a bottom surface located below a bottom surface of a member to be protected such as fuel tanks.
